(19) United States
(12) Patent Application Publication
(10) Pub. No.: US 2010/0177805 A1
(43) Pub. Date: Jul. 15, 2010

(54) Multipath Tracking Device and Method in A CDMA Communication System

(76) Inventors: Chao Li, Beijing (CN); Chaolun Xu, Beijing (CN); Kangqiang Gao, Beijing (CN)

Correspondence Address: JOHN ALEXANDER GALBREATH, 2516 CHESTNUT WOODS CT, REISTERSTOWN, MD, 21136, US

(21) Appl. No.: 12/663,286

(22) PCT Filed: Jul. 18, 2007
(86) PCT No.: PCT/CN07/70316

§ 371 Date: Dec. 29, 2009

(30) Foreign Application Priority Data
Jun. 6, 2007 (CN) 200710110569.3

(51) Int. Cl. H04B 1/707

(52) U.S. Cl. 375/144; 375/E01.032

(57) ABSTRACT

A multipath tracking device and method in a CDMA communication system adds a middle path power estimation unit, a normalization processing unit and a nonlinear mapping unit in an existing multipath tracking device. A precise current middle path signal power is acquired by the middle path power estimation unit; the normalization processing is performed for the power errors of the late, early path signals in the normalization processing unit, and thus the impact of the middle path signal power on the power error is eliminated, the active normalization for the power error is realized; after obtaining the smooth and stable normalized power error signal, the precise delay error signal is determined in the nonlinear mapping unit according to the nonlinear mapping relation between the normalized power error signal and the delay error signal, thereby the precise voltage control signal is acquired.

### FIELD OF THE INVENTION

The present invention relates to multipath tracking technology, and more particularly, to a multipath tracking device and method in a Code Division Multiple Access (CDMA) communication system.

### BACKGROUND OF THE INVENTION

Comparing with the traditional technologies of Frequency Division Multiple Access (FDMA) and Time Division Multiple Access (TDMA), CDMA technology has obvious advantages for its benefits of large capacity, multiuser, soft capacity, and system in-band noise reduction. Therefore, the third Generation (3G) wireless communication system based on the CDMA technology becomes a vigorously promoting mainstream commercial wireless communication system.

In the CDMA wireless communication system, on the one hand, the signals will be affected by the block, refraction, reflection and scattering of an obstacle or ionosphere when transmitting in the air, and on the other hand, the signals with limited bandwidth will be shifted and spread in the frequency domain when transmitting in the air. Accordingly, signals received by a RAKE receiver are no longer direct signals from one path, but signals from different directions via different paths. The original data transmitted in the signals from a plurality of paths are same signals with different delays. The signals from a plurality of paths are superposed copies of signals transmitted independently with each other. Such kind of signals which come from same data source via different path is generally called as multipath signal. The data symbol is spread by a long Pseudo-Noise (PN) sequence. Thereby the continuing time of each chip is very short. In such a way, signals transmitted to the RAKE receiver via different paths can be separated effectively on the chip.

In the wireless communication system, accurate time synchronization is very important. Whether the synchronization is achieved or not and the effective accuracy of the synchronization will directly affect whether the wireless communication system can work or not and the work capability. In the wireless communication system employing CDMA technology, that is, in the CDMA wireless communication system, time synchronization is even more important. The requirement for the accuracy of the time synchronization is often shorter than the time length of one chip, such as 1/16 chip. The reason why the CDMA wireless communication system has such a high requirement of time synchronization is that the CDMA wireless communication system distinguishes different districts via different scrambling codes and distinguishes different users via different spreading codes. When the synchronization accuracy of the CDMA wireless communication system fails to meet the requirement, the Multiple Access Interference (MAI), Inter-symbol Interference (ISI), and the Multipath Interference (MPI) affecting the user may increase sharply. In the condition of multidistrict or multiuser, inaccurate synchronization may badly affect the QoS of the CDMA wireless communication system, and even result in incorrect operation of the CDMA wireless communication system when the synchronization is seriously inaccurate.

Thus, it is very important for CDMA wireless communication system to capture and lock signals on each path at accurate time. At present, capturing signals from each path is achieved by multipath searching, which can be used for capture of each multipath location of the receiving signal, and has a precision not lower than ½ chip. However, in the actual application, on the one hand, the location of each multipath signal always shifts in a certain range for various reasons, and on the other hand, the precision of captured location is not enough for the RAKE receiver. In order to capture the multipath locations more accurately, as well as keep each multipath location within the range of the design precision, multipath tracking method is always employed. The multipath tracking scheme used frequently is a multipath tracking circuit based on a Delay-Locked Loop (DLL) of early-late gate. The so called “early-late gate” is used to divide a signal into an early path signal and a late path signal. The signal has a lead delay of Δ chip comparing with the correct delay is called as an early path signal, and the signal has a lag delay of Δ chip comparing with the correct delay is called as a late path signal.

FIG. 1 is the structure diagram of an existing multipath tracking device. As shown in FIG. 1, the multipath tracking device comprises a late path pilot symbol power acquiring unit 101, an early path pilot symbol power acquiring unit 102, an early-late gate power error acquiring unit 103, a loop filtering unit 104, a phase tracking control unit 105, a Voltage Controlled Oscillator (VCO) 106, and a PN code generator 107. Wherein, the late path pilot symbol acquiring unit 101 is used to generate late path signal power according to the received late path signal and the PN code from the PN code generator 107, and output the late path signal power to the early-late gate power error acquiring unit 103. The early path pilot symbol power acquiring unit 102 is used to generate early path signal power according to the received early path signal and PN code from the PN code generator 107, and output the early path signal power to the early-late gate power error acquiring unit 103. The early path signal and late path signal both are complex signal with I path and Q path together. The early-late gate power error acquiring unit 103 is used to calculate power error of the late path signal and early path signal according to the received late path signal power and the early path signal power, and convert the power error into delay error, and then output the delay error to the loop filtering unit 104. The loop filtering unit 104 is used to filter interference on the received delay error and loop noise, so as to obtain smooth and stable delay error signal of the early and late path, and then output the delay error signal to the phase tracking control unit 105. The phase tracking control unit 105 is used to convert the received delay error signal into voltage control signal corresponding to the VCO 106 according to the response characteristic of the VCO 106, and output the voltage control signal to the VCO 106. The VCO 106 is used to control the PN code generator 107 to generate PN code according to the received voltage control signal. The PN code generator 107 is adjusted by the control voltage of the VCO 106 to generate PN code which is output to the late path pilot symbol power acquiring unit 101 and early path pilot symbol power acquiring unit 102 for locking the multipath location via adjusting and locking the phase of the PN code.

The expressions of power error signal of the late path signal and early path signal eᵢ(ε): eᵢ(ε)=K·Pᵢ·[g²((ε−5)T_{c})−g²((ε+0.5)T_{c})], wherein, K is a constant, P is complex power of current middle path despread symbol, that is, complex power of current middle path signal after despeading, c is delay error signal of loop of normalized chip, function g(εT_{c}) is normalized unit impluse response after match filtering of the receiver. The receiving filter is a filter located at the front end of the RAKE receiver for receiving initial receiving signal, and generally is a root raised cosine filter, such as in a 3rd Generation Partnership Project system. At this time, the impluse response of the receiving filter is raised cosine filter after the matching filter of the receiving end. Now, the expressions of g(εT_{c}) is

$$g ( ɛ {T}_{c} ) = \frac{sin ( πɛ )}{π ɛ} \cdot \frac{cos ( π ɛ )}{1 - {( 2 α ɛ )}^{2}} ,$$

wherein, α is the roll-off factor of the receiving filter, such as 0.22 in 3GPP FDD.

It can be seen from the expressions of eᵢ(ε) that, eᵢ(ε) comprises Pᵢ, so the delay error signal obtained from eᵢ(ε) also comprises influence of Pᵢ, which may results in many problems. Firstly, Pᵢ is power value of pilot signal, which is obtained by descrambling and despreading transmitting signal which arrived at the RAKE receiver after being influenced and attenuated in the channel. Due to the mobility of the terminal, the time variation of the wireless communication and the non ideality of power controlling, Pᵢ will have a big fluctuation; sometimes the fluctuation range may be up to 2-4 magnitudes. Accordingly, if corresponding process isn't performed on the eᵢ(ε) so as to eliminate influence of Pᵢ, which may result in big fluctuation on the obtained eᵢ(ε), and thus signals from each path can't be synchronized and tracked accurately according to such eᵢ(ε).

### SUMMARY OF THE INVENTION

In view of this, the main objective of this invention is to provide a multipath tracking device and method in a Code Division Multiple Access communication system, so as to synchronize and track signals from each path accurately.

In order to achieve the above objective, the technical solution of present invention is implemented as follows.

The present invention provide a multipath tracking device and method in a Code Division Multiple Access communication system, which comprises: a late path pilot symbol power acquiring unit, an early path pilot symbol power acquiring unit, a middle path pilot symbol power acquiring unit, an early-late gate power error acquiring unit, a middle path power estimation unit, a normalization processing unit, a loop filtering unit, a nonlinear mapping unit, a phase tracking control unit, a voltage controlled oscillator, and a PN code generator; wherein, the late path pilot symbol power acquiring unit is used to generate late path signal power according to the received late path signal and the PN code from the PN code generator, the early path pilot symbol power acquiring unit is used to generate early path signal power according to the received early path signal and the PN code from the PN code generator, the middle path pilot symbol power acquiring unit is used to generate middle path signal power according to the received middle path signal and the PN code from the PN code generator, the early-late gate power error acquiring unit is used to calculate power error of the late path signal and early path signal according to the received late path signal power and early path signal power, the middle path power estimation unit is used to determine accurate current power of middle path signal according to the middle path signal power, the normalization processing unit is used to implement normalization process on the power error according to the accurate current middle path signal power, and obtain normalized power error, the loop filtering unit is used to filter interference on the normalized power error and loop noise, so as to obtain smooth and stable normalized power error signal, the nonlinear mapping unit is used to determine delay error signal corresponding to the normalized power error signal based on the corresponding relationship between the stored normalized power error signal and delay error signal, the phase tracking control unit is used to convert the received delay error signal into voltage control signal corresponding to the VCO according to the response characteristic of the VCO; the VCO is used to control the PN code generator to generate PN code according to the voltage control signal, the PN code generator is adjusted by the control voltage of the VCO to generate PN code which is output to the late path pilot symbol power acquiring unit, early path pilot symbol power acquiring unit and middle path pilot symbol power acquiring unit respectively.

Advantagely, the middle path power estimation unit is further used to receive the late path signal power and early path signal power, and determine accurate current middle path signal power according to the power of the late, early and middle path signal.

Advantagely, the normalization processing unit is further used to implement N-point sliding weighted averaging to the middle path signal power.

The present invention provides a multipath tracking method, which comprising: determining power error of a late path signal and an early path signal according to PN code, late path signal and early path signal, and acquiring accurate current middle path signal power; implementing normalization process on the power error according to the current middle path signal power, and obtaining a normalized power error signal, then determining a delay error signal corresponding to the obtained normalized power error signal according to the nonlinear mapping relationship between the normalized power error signal and the delay error signal; converting the delay error signal into a voltage controlled signal for controlling the generation of a PN code, and locking the multipath location through adjusting and locking the phase of the PN code.

Correspondingly, the step of acquiring accurate current middle path signal power comprises using the current middle path signal power as the accurate current middle path signal power directly, or determining accurate current middle path signal power according to each power of the late, early and middle path signal.

Correspondingly, the step of determining accurate current middle path signal power according to each power of the late, early and middle path signal comprises using Sᵢ=(P_{i,E}+P_{i,L}+P_{i,O})/(1+2g²(0.5T_{c})), wherein, Sᵢ is accurate current middle path signal power, P_{i,E} is early path signal power, P_{i,L} is late path signal power, P_{i,o} is middle path signal power, (1+2g²(0.5T_{c}) is a constant; or using Sᵢ=(P_{i,E}+P_{i,L}+P_{i,O}−Min(P_{i,E},P_{i,L},P_{i,O}))/(1g²(0.5T_{c})), wherein, Sᵢ is accurate current middle path signal power, P_{i,E} is early path signal power, P_{i,L} is late path signal power, P_{i,o} is middle path signal power, 1+g²(0.5T_{c}) is a constant.

Correspondingly, the nonlinear mapping relationship between the normalized power error signal and the delay error signal is: η̅ᵢ(ε)=g²((ε−0.5)T_{c})−g²((ε+0.5)T_{c}), wherein, η̅ᵢ(ε) is normalized power error signal, ε is delay error signal and −0.5T_{c}≦ε≦0.5T_{c}, ε is value corresponding to the η̅ᵢ(ε).

Correspondingly, before the normalization process, the method further comprise implementing N-point sliding weighted averaging

$${\hat{P}}_{i} = {\sum }_{k = 1}^{N} {w}_{k} \cdot {s}_{i - k}$$

to the middle path signal power, wherein, \hat{P}ᵢ is the weighted averaging power of the middle path signal, Sᵢ₋ₖ is the estimated power of the kth middle path signal before the current signal sᵢ, wₖ is the filter coefficient,

$${\sum }_{k = 1}^{N} {w}_{k} = 1.$$

Correspondingly, the filter coefficient uses averaging weighting filtering, or polynomial weighting filtering, or exponential weighting filtering.

In the present invention, a middle path power estimation unit, a normalization processing unit and a nonlinear mapping unit are added in the present multipath tracking device.

Through acquiring accurate current middle path signal power by employing middle path power estimation unit, implementing normalization process on the power error of the late and early path signal power in the normalization processing unit so as to eliminate influence of the middle path signal power on the power error, and realize effective normalization, a smooth and stable normalized power error signal is obtained; then accurate delay error signal is determined according to the nonlinear mapping relationship between the normalized power error signal and delay error signal. In such a way, the voltage controlled signal obtained by the delay error signal is more accurate, and then the PN code generated under the control of the voltage controlled signal may lock the multipath location accurately, the precision of the multipath tracking is effectively improved and the timing jitter also can be reduced.

Moreover, the normalization processing unit is further used to implement N-point sliding weighted averaging to the middle path signal power, so as to obtain more accurate middle path signal power.

### BRIEF DESCRIPTION OF THE DRAWINGS

FIG. 1 is a structure diagram of a multipath tracking device according to the prior art;

FIG. 2 is a diagram showing the unit impluse response power of a raised cosine filter;

FIG. 3 is a structure diagram of a multipath tracking device according to the present invention;

FIG. 4A is a diagram showing the character of detected phase between the power error signal and the delay error signal employed in the prior art;

FIG. 4B is a diagram showing the character of detected phase between the normalized power error signal and the delay error signal employed in the present invention;

FIG. 5 is a detail structure diagram of a multipath tracking device according to the present invention;

FIG. 6 is a comparison diagram between the present invention and the prior art on the mapping relationship from the power error signal to the delay error signal.

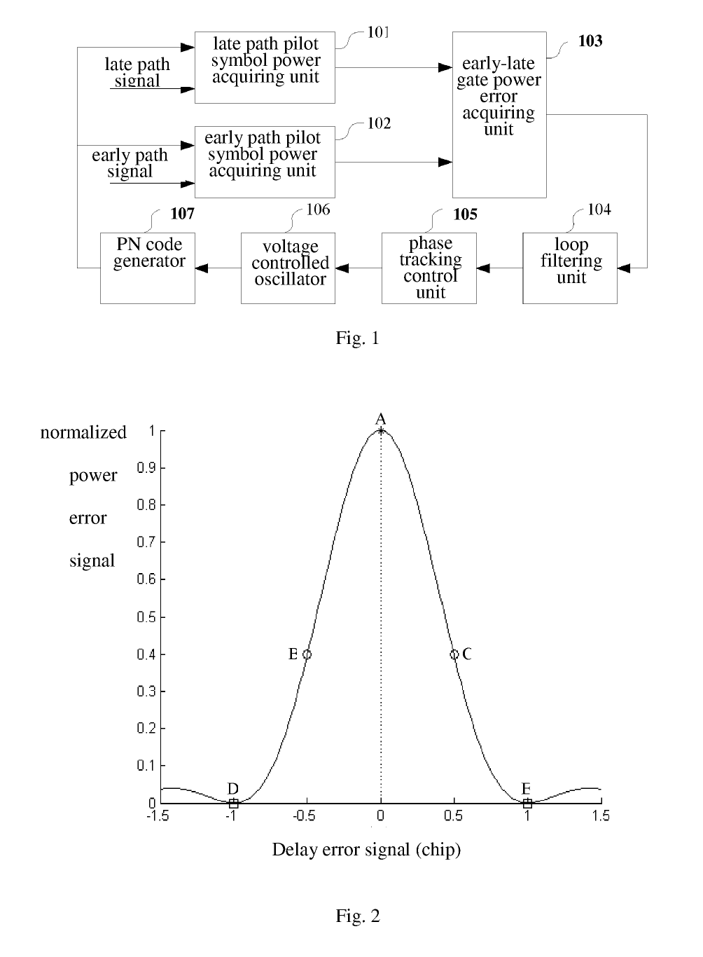

### DETAILED DESCRIPTION OF THE PREFERRED EMBODIMENT

As the power error signal eᵢ(ε) of the late, early path signal involves current middle path signal power Pᵢ, so Pᵢ should be estimated accurately and then be eliminated in eᵢ(ε), in such a way, a normalized power error signal can be obtained, and then accurate tracking and synchronization can by implemented in the further process according to the obtained normalized power error signal.

Pᵢ is the power of a despread current middle path signal which should be estimated accurately for eliminating the influence of Pᵢ and obtaining a normalized power error signal. FIG. 2 is a diagram showing the unit impluse response power of a raised cosine filter. As shown in FIG. 2, a raised cosine filter is used to receive the response of the filter, the unit impluse response power of which is expressed as g²(εT_{c}). If the captured multipath is completely accurate, Pᵢ is corresponding to the point A in the FIG. 2, and if delay error (such as a delay error of [−½, ½] chip) presents in the captured multipath, P is corresponding to a region between point A and point B in the FIG. 2, and in this case, the estimation of Pᵢ is inaccurate. Accordingly, it is very important to estimate Pᵢ accurately.

In the present invention, power error of a late path signal and an early path signal is determined according to the PN code, the late path signal and the early path signal, an accurate current middle path signal power is also acquired, then normalization process is implemented on the power error of the late path signal and the early path signal according to the current middle path signal power to obtain a normalized power error signal, then a delay error signal corresponding to the obtained normalized power error signal is obtained according to the nonlinear mapping relationship between the normalized power error signal and the delay error signal, then the delay signal is converted into a voltage controlled signal for controlling the generation of a PN code, finally, the multipath location is locked through adjusting and locking the phase of the PN code.

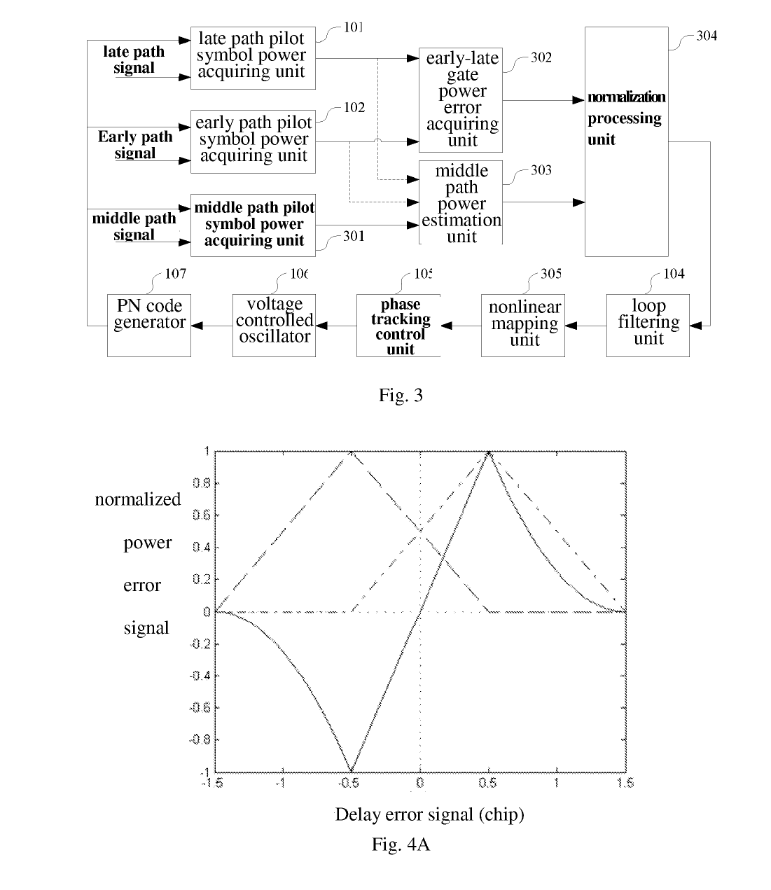

FIG. 3 is a structure diagram of a multipath tracking device according to the present invention. As shown in FIG. 3, the multipath tracking device comprises: a late path pilot symbol power acquiring unit 101, an early path pilot symbol power acquiring unit 102, a middle path pilot symbol power acquiring unit 301, an early-late gate power error acquiring unit 302, a middle path power estimation unit 303, a normalization processing unit 304, a loop filtering unit 104, a nonlinear mapping unit 305, a phase tracking control unit 105, a voltage controlled oscillator 106, and a PN code generator 107. Comparing with the existing multipath tracking device, the multipath tracking device according to the present invention further comprises the middle path pilot symbol power acquiring unit 301 for receiving middle path signal, the middle path power estimation unit 303, the normalization processing unit 304 and the nonlinear mapping unit 305. Moreover, the function of early-late gate power error acquiring unit 302 is different from the existing early-late gate power error acquiring unit 103. Detail description has been made to each unit of the existing multipath device in the background, so only the differences between the present invention and the existing art on implementation and connection relation of each unit as well as the implementation of the new added units are described.

The middle path pilot symbol power acquiring unit 301 is used to generate middle path signal power according to the received middle path signal and the PN code from the PN code generator 107, and then output the middle path signal power to the middle path power estimation unit 303. The middle path power estimation unit 303 is used to determine accurate current power of middle path signal according to the middle path signal power, and then output the accurate current power of middle path signal to the normalization processing unit 304. Herein, for the CDMA wireless communication system, the signal power of each path is commonly a power of a despread symbol on a continuing pilot channel, for example, the power of a despread symbol on a common pilot channel in the Wide-band Code Division Multiple Access. The implementation of the middle path power estimation unit 303 may have two different ways, one of which is that, the middle path power estimation unit 303 only receives current middle path signal power outputted from the middle path pilot symbol power acquiring unit 301, at this time, the middle path power estimation unit 303 uses the present current middle path signal power as an accurate current middle path signal power; anther of which is that the middle path power estimation unit 303 not only receives current middle path signal power outputted from the middle path pilot symbol power acquiring unit 301, but also receives the early path signal power and late path signal power each from the late path pilot symbol power acquiring unit 101 and early path pilot symbol power acquiring unit 102, at this time, the middle path power estimation unit 303 determines accurate current middle path signal power according to the power of the late, early and middle path signal respectively. In order to provide more accurate current middle path signal power, the normalization processing unit 304 may make a further smoothing process to the middle signal power, that is, implementing N-point sliding weighted averaging to the middle path signal power, after receiving the accurate current middle path signal power provided by the middle path power estimation unit 303.

The early-late gate power error acquiring unit 302 is used to calculate power error of the early path signal and the late path signal according to the received early path signal power and the late path signal power, and output the power error to the normalization processing unit 304. The normalization processing unit 304 is used to implement normalization process on the power error based on the accurate current middle path signal power, and output the normalized power error to the loop filter unit 104. The loop filtering unit 104 is used to filter interference on the normalized power error and loop noise, so as to obtain smooth and stable normalized power error signal, and then output the normalized power error signal to nonlinear mapping unit 305. The nonlinear mapping unit 305 is used to determine delay error signal corresponding to the normalized power error signal based on the stored corresponding relationship between the normalized power error signal and the delay error signal, and then output the delay error signal to the phase tracking control unit 105. The functions of the phase tracking control unit 105, VCO 106, and PN code generator 107 are the same as the prior art.

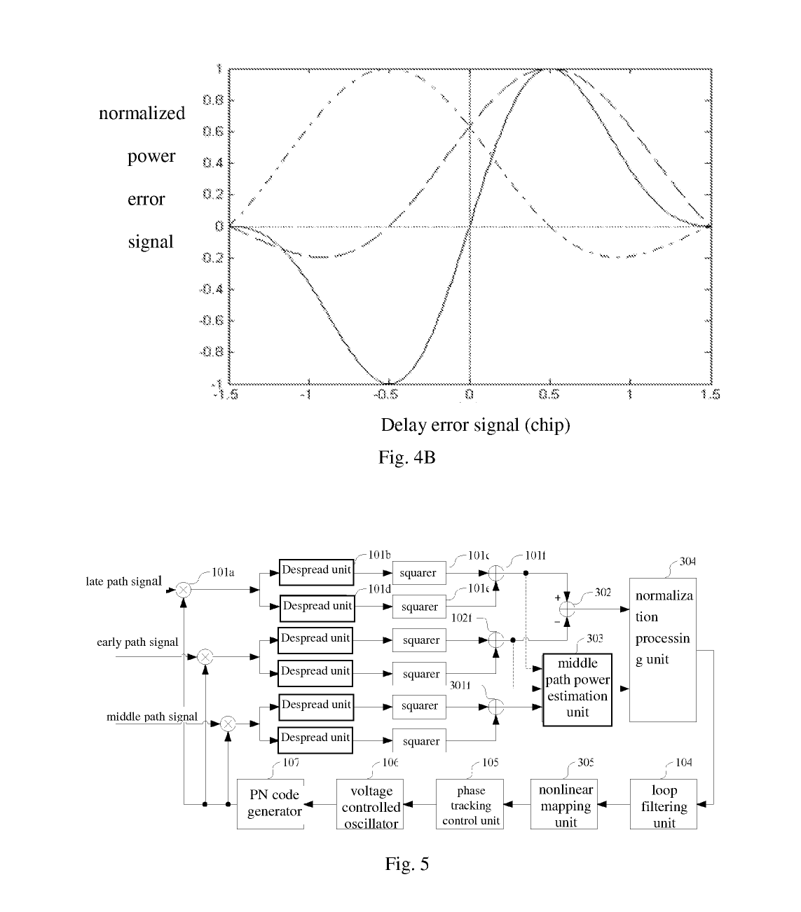

The power error of the late and early path signal is eᵢ(ε)=K·Pᵢ·[g²((ε−0.5)T_{c})−g²((ε+0.5)T_{c})], in such a way, when accurate current middle path signal power is obtained, the normalization processing unit 304 may obtain normalized power error ηᵢ(ε)eᵢ(ε)/(K·Pᵢ)=g²((ε−0.5)T_{c})−g²((ε+0.5)T_{c}), and a filtered normalized power error is η̅ᵢ(ε)=g²((ε−0.5)T_{c})−g²((ε+0.5)T_{c}). According to the expression of η̅ᵢ(ε), it can be seen that character of detected phase between η̅ᵢ(ε), and delay error signal isn't like the simple linear relationship shown in FIG. 4A and being employed in the prior art, but the non-linear relationship shown in FIG. 4B, so the value taking relationship between the η̅ᵢ(ε) and ε should be determined according to the expression. The nonlinear mapping unit 305 may determine ε, −0.5T_{c}≦ε≦0.5T_{c}, through η̅ᵢ according to the expression. When the roll-off factor α is different, the corresponding relationship between η̅ᵢ(ε) and ε should be different, but once α is determined, the corresponding relationship between η̅ᵢ and ε is determined.

FIG. 5 is a detail structure diagram of a multipath tracking device according to the present invention. As shown in FIG. 5, the late path pilot symbol power acquiring unit 101, the early path pilot symbol power acquiring unit 102 and the middle path pilot symbol power acquiring unit 301 each comprises one multiplier, two despread units, two squarers and one adder. Now, takes the late path pilot symbol power acquiring unit 101 for example, and provide a description to the detail function of the contained units. Multiplier 101a is used to multiply the received late path signal with PN code from the PN code generator 107, and then separate the obtained multiplied complex signal of I path and Q path into I path signal and Q path signal and output them to the despread units 101b and 101d respectively. The despread unit is used to despread the received signals, and output the despread signal to the squarer. The despread unit 101b output the despread signal to square 101c, the despread unit 101d output the despread signal to square 101e. The square 101c and 101e implement a squaring process on the received despread signal, and output the signal to adder 101f. The adder 101f adds the received signal together, and output the summing signal to the early-late gate power error acquiring unit 302, and the summing signal is the late path signal power. The early-late gate power error acquiring unit 302 may be implemented by a subtracter, that is, the output of adder 101f is used to subtract the output of adder 102f, and the difference obtained by subtracting is send to the normalization processing unit 304 by subtracter 302. If the outputs of adders 101f and 102f are not sent to middle path power estimation unit 303, the output of adder 301f may be sent to the middle path power estimation unit 303 as accurate current middle path signal power. If the output of adder 101f, adder 102f and adder 301f are all sent to the middle path power estimation unit 303, then the middle path power estimation unit 303 determines accurate current middle path signal power according to each power of the late, early and middle path signal.

The detail process of determining accurate current middle path signal power according to each power of the late, early and middle path signal may be that: take the ratio between the sum of the late, early and middle path signal power to the constant as accurate current middle path signal power, which can be expressed as Sᵢ=(P_{i,E}+P_{i,L}+P_{i,O})/(1+2g²(0.5T_{c})), wherein, Si is accurate current middle path signal power, P_{i,E} is early path signal power, P_{i,L} is late path signal power, P_{i,o} is middle path signal power, 1+2g²(0.5T_{c}) is a constant.

The detail process of determining accurate current middle path signal power according to each power of the late, early and middle path signal may be that use the sum of each late, early and middle path signal power to subtract the minimum among late, early and middle path signal power, then ratio with the constant, and take the obtained ratio as accurate current middle path signal power, which can be expressed as Sᵢ=(P_{i,E}+P_{i,L}+P_{i,O}−Min(P_{i,E},P_{i,L},P_{i,O}))/(1+g²(0.5T_{c})). Combing with FIG. 2, if the captured multipath has no error, the middle path signal is at the point A in the FIG. 2, the early path signal is at the point B in the FIG. 2, and the late path signal is at the point C in the FIG. 2, P_{i,E}+P_{i,L}+P_{i,O}−Min(P_{i,E},P_{i,L},P_{i,O}) is the sum of the power of point A and the power of the larger one of points C and B, then, the accurate current middle path signal power may be obtained though normalization process 1+g²(0.5T_{c}). If the multipath searching isn't accurate, for example, the middle path signal is corresponding to the point C in FIG. 2, and then the early path signal will be corresponding to the point A in FIG. 2, and the late path signal will be corresponding to the point E in FIG. 2. At this time, accurate current middle path signal power obtained according to P_{i,E}+P_{i,L}+P_{i,O}−Min(P_{i,E},P_{i,L},P_{i,O}) is also the sum of the power of point A and point C. After normalization process through 1+g²(0.5T_{c}), same results as when multipath has no error will be obtained.

When the normalization processing unit 304 receives accurate current middle path signal power provided by the middle path power estimation unit 303, the normalization processing unit 304 may make a further smoothing process to the middle signal power, that is, implementing N-point sliding weighted averaging to the middle path signal power, that is,

$${\hat{P}}_{i} = {\sum }_{k = 1}^{N} {w}_{k} \cdot {s}_{i - k} ,$$

weighted filter is implemented on each middle path signal power obtained at the foregoing N−1 times together with the current middle path signal power value Sᵢ, wherein, \hat{P}ᵢ is the weighted averaging power of the middle signal, wₖ is the filter coefficient which satisfy the condition of

$${\sum }_{k = 1}^{N} {w}_{k} = 1 ,$$

k is the kth weighted coefficient, Sᵢ₋ₖ is the estimated power of the kth middle path signal before the current signal Sᵢ. wₖ may employ averaging weighted filter, that is wₖ=1/N, or polynomial weighted filter, that is, wₖ=a₀·k^{p}+a₁·k^{p-1}+ . . . +aₚ₋₁, wherein, p is the order of the polynomial. Moreover, exponential weighted filter can also be employed, that is, wₖ=b₀·a^{-b}^{₁}^{·k}, wherein, a [symbol] b₀ [symbol] b₁ are constants.

The embodiment of the nonlinear mapping between the normalized power error signal η̅ᵢ(ε) and the delay error signal ε is described in following example. If the roll-off factor α is 0.22, the tracking precision design of the multipath device is 1/16 chip, the corresponding relationship between η̅ᵢ and ε is shown in table 1:

TABLE 1
The mapping relationship table between η̅ᵢ and ε

| | η̅ᵢ | | | | | | | | |
|---|---|---|---|---|---|---|---|---|---|
| | 0 | 0.2011 | 0.3935 | 0.5690 | 0.7204 | 0.8421 | 0.9302 | 0.9828 | ≧1 |
| ε | 0 | 1/16 | 2/16 | 3/16 | 4/16 | 5/16 | 6/16 | 7/16 | 8/16 |

In the nonlinear mapping unit 305, the received η̅ᵢ(ε) is compared with n̅ᵢ in the corresponding relationship table, taking the η̅ᵢ most close to η̅ᵢ(ε) as η̅ᵢ(ε), so the ε corresponding to the ηᵢ is the wanted delay error signal. For example, when the received η̅ᵢ(ε) is 0.61, the value of in the table most close to 0.61 is 0.5690. Accordingly, 3/16 corresponding to 0.5690 is the value of c. For further example, the received η̅ᵢ(ε) of the nonlinear mapping unit 305 is −0.84, in the corresponding relationship table, the value of η̅ᵢ most close to 0.84 is 0.8421, so the value of ε corresponding to 0.8421 is 5/16. As η̅ᵢ(ε) is −0.84, so the last wanted value of ε is − 5/16. Herein, just a simple example of the present invention is disclosed. When the filter or tracking precision is different, the value of each portion in the corresponding relationship table is different. However, the implementing method is the same.

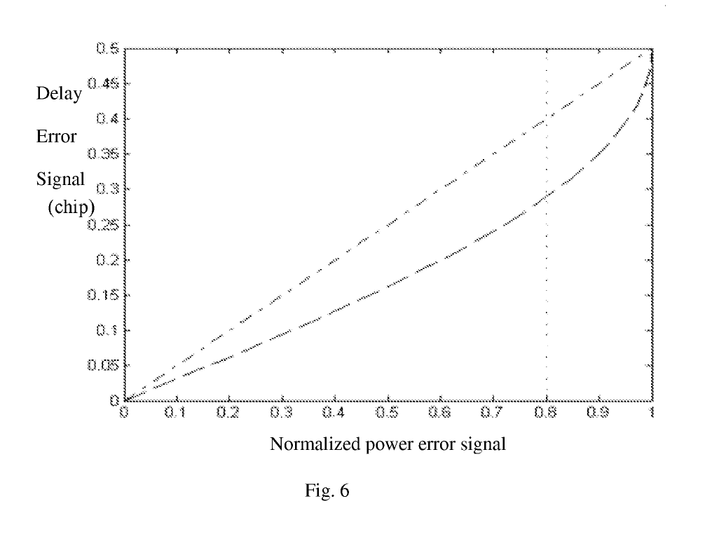

FIG. 6 is a comparison diagram between the present invention and the prior art on the mapping relationship from the power error signal to the delay error signal. As shown in FIG. 6, only the shape of positive half is described. As there is large mapping error in the prior art, it can be seen in the figures that the delay error signal determined by the nonlinear mapping of the present invention is more accurate than that determined by the prior art. For example, when η̅ᵢ(ε) is 0.4063, ε determined by the prior art is 0.4063, but the ε determined by the present invention is 0.2969 with a difference of 0.1094, which is large for a system with a precision of 1/16. And this error is resulted from the non-scientific of the mapping method itself, and can't be corrected by other methods. It can be seen that, the nonlinear mapping method of the present invention can improve the tracking precision effectively.

The foregoing description is just the preferred embodiment of the invention. It is not intended to exhaustive or to limit the invention.

What is claimed is:

1. A multipath tracking device in a Code Division Multiple Access communication system, wherein, comprises a late path pilot symbol power acquiring unit, an early path pilot symbol power acquiring unit, a middle path pilot symbol power acquiring unit, an early-late gate power error acquiring unit, a middle path power estimation unit, a normalization processing unit, a loop filtering unit, a nonlinear mapping unit, a phase tracking control unit, a voltage controlled oscillator, and a PN code generator, wherein,
the late path pilot symbol power acquiring unit is used to generate late path signal power according to the received late path signal and PN code from the PN code generator;
the early path pilot symbol power acquiring unit is used to generate early path signal power according to received early path signal and PN code from the PN code generator;
the middle path pilot symbol power acquiring unit is used to generate middle path signal power according to received middle path signal and PN code from the PN code generator;
the early-late gate power error acquiring unit is used to calculate power error of the late path signal and the early path signal according to the received late path signal power and the early path signal power;
the middle path power estimation unit is used to determine accurate current power of middle path signal according to the middle path signal power;
the normalization processing unit is used to implement normalization process on the power error according to the accurate current middle path signal power, and obtain normalized power error;
the loop filtering unit is used to filter interference on the normalized power error and loop noise, so as to obtain smooth and stable normalized power error signal;
the nonlinear mapping unit is used to determine delay error signal corresponding to the normalized power error signal based on the corresponding relationship between the stored normalized power error signal and delay error signal;
the phase tracking control unit is used to convert the received delay error signal into voltage control signal corresponding to the VCO according to the response characteristic of the VCO;
the VCO is used to control the PN code generator to generate PN code according to the voltage control signal;
the PN code generator is adjusted by the control voltage of the VCO to generate PN code which is output to the late path pilot symbol power acquiring unit, early path pilot symbol power acquiring unit and middle path pilot symbol power acquiring unit respectively.

2. The device according to claim 1, wherein, the middle path power estimation unit is further used to receive the late path signal power and the early path signal power, and determine accurate current middle path signal power according to the power of the late, early and middle path signal.

3. The device according to claim 1 or 2, wherein, the normalization processing unit is further used to implement N-point sliding weighted averaging to the middle path signal power.

4. A multipath tracking method in a Code Division Multiple Access communication system, wherein, which comprising:
determining power error of a late path signal and an early path signal according to PN code, late path signal and early path signal, and acquiring accurate current middle path signal power;
implementing normalization process on the power error according to the current middle path signal power, and obtaining a normalized power error signal, then determining a delay error signal corresponding to the obtained normalized power error signal according to the nonlinear mapping relationship between the normalized power error signal and the delay error signal;
converting the delay error signal into a voltage controlled signal for controlling the generation of a PN code, and locking the multipath location through adjusting and locking the phase of the PN code.

5. The method according to claim 4, wherein, the step of acquiring accurate current middle path signal power comprises:
using the current middle path signal power as the accurate current middle path signal power directly; or
determining accurate current middle path signal power according to each power of the late, early and middle path signal.

6. The method according to claim 5, wherein, the step of determining accurate current middle path signal power according to each power of the late, early and middle path signal comprises:
using Sᵢ=(P_{i,E}+P_{i,L}+P_{i,O})/(1+2g²(0.5T_{c}), wherein, Sᵢ is accurate current middle path signal power, P_{i,E} is early path signal power, P_{i,L} is late path signal power, P_{i,o} is middle path signal power, (1+2g²(0.5T_{c}) is a constant; or
using Sᵢ=(P_{i,E}+P_{i,L}+P_{i,O}−Min(P_{i,E},P_{i,L},P_{i,O}))/(1+g²(0.5T_{c})), wherein, Sᵢ is accurate current middle path signal power, P_{i,E} is early path signal power, P_{i,L} is late path signal power, P_{i,o} is middle path signal power, 1+g²(0.5T_{c}) is a constant.

7. The method according to any one of claim 4-6, wherein, the nonlinear mapping relationship between the normalized power error signal and the delay error signal is: η̅ᵢ(ε)=g²((ε−0.5)T_{c})−g²((ε+0.5)T_{c}), wherein, η̅ᵢ(ε) is normalized power error signal, ε is delay error signal and −0.5T_{c}≦ε≦0.5T_{c}, ε is value corresponding to the η̅ᵢ(ε).

8. The method according to any one of claim 4-6, wherein, before the normalization process, the method further comprise implementing N-point sliding weighted averaging
$${\hat{P}}_{i} = {\sum }_{k = 1}^{N} {w}_{k} \cdot {s}_{i - k}$$
to the middle path signal power, wherein, \hat{P}ᵢ is the weighted averaging power of the middle path signal, sᵢ₋ₖ is the estimated power of the kth middle path signal before the current signal sᵢ, wₖ is the filter coefficient,
$${\sum }_{k = 1}^{N} {w}_{k} = 1.$$

9. The method according to claim 8, wherein, the filter coefficient uses averaging weighting filtering, or polynomial weighting filtering, or exponential weighting filtering.
